(19) United States
(12) Patent Application Publication
(10) Pub. No.: US 2011/0088506 A1
(43) Pub. Date: Apr. 21, 2011

(54) PUMP TAPPET

(75) Inventors: Shinji Oishi, Shizuoka (JP); Masahiko Kataoka, Shizuoka (JP); Katsufumi Abe, Shizuoka (JP)

(73) Assignee: NTN Corporation, Osaka (JP)

(21) Appl. No.: 12/992,290

(22) PCT Filed: Apr. 28, 2009
(86) PCT No.: PCT/JP2009/058384

§ 371 Date: Nov. 12, 2010

(30) Foreign Application Priority Data
May 12, 2008 (JP) 2008124154
Jun. 2, 2008 (JP) 2008144792
Jun. 2, 2008 (JP) 2008144793
Jun. 2, 2008 (JP) 2008144794
Jun. 2, 2008 (JP) 2008144797
Jun. 9, 2008 (JP) 2008150989

(51) Int. Cl. F04B 9/04; F16H 53/06

(52) U.S. Cl. 74/569

(57) ABSTRACT

A pump tappet (21) transmits a rotation movement of a cam shaft (12) provided with a cam (12a) to a pump plunger (13) as a reciprocation linear movement, and performs a reciprocation linear movement together with the pump plunger (13). The pump tappet (21) includes a shaft (22), a roller bearing (31) arranged on an outer diameter side of the shaft (22) and rotatably supported on the shaft (22), and a case (23) to house the shaft (22) and the roller bearing (31). The roller bearing (31) includes an outer ring (32) abutting on the cam (12a), a plurality of rollers (33) arranged between the outer ring (32) and the shaft (22), and a retainer (34) to retain the plurality of rollers (33).

### TECHNICAL FIELD

The present invention relates to a pump tappet and more particularly to a pump tappet including a roller bearing.

### BACKGROUND ART

A high-pressure pump to inject a fuel with high pressure is provided in an engine of a car and the like, in some cases. The high-pressure pump converts a rotation movement of a cam shaft provided with a cam to a reciprocation linear movement of a pump plunger, boosts a pressure in a high-pressure chamber by supplying gas by the reciprocation linear movement of the pump plunger, and injects and supplies the fuel into a fuel chamber. A component member of the high-pressure pump includes a pump tappet to transmit the rotation movement of the cam shaft to the pump plunger as the reciprocation linear movement. There are various kinds of pump tappets such as a tappet including a roller, and a mushroom type tappet, depending on a shape of a contact part with the cam.

Here, a technique regarding a pump tappet including a roller bearing is disclosed in DE 10 2005 047 234 A1 (patent document 1). FIG. 24 is a cross-sectional view of the pump tappet disclosed in the patent document 1. Referring to FIG. 24, a roller push rod 101 serving as a tappet shown in the patent document 1 has a push rod housing 102, and a push rod roller 103 (roller bearing) fixed thereto and supported by a needle. The roller push rod 101 is driven by a three-stage cam 105 of a cam shaft 104 rotating clockwise. Thus, the roller push rod 101 is guided in an axial direction shown by an arrow XXIV in FIG. 24 in a push rod guide hole 106, and drives a pump plunger 107 of a fuel high-pressure pump (not shown).

The push rod roller 103 includes an outer ring 108 abutting on the three-stage cam 105, a shaft 109 arranged on the inner diameter side of the outer ring 108, and a plurality of needle rollers 110 arranged between the outer ring 108 and the shaft 109. The push rod roller 103 is a full-roller type, that is, a type in which only a plurality of needle rollers 110 are arranged between the outer ring 108 and the shaft 109.

### RELATED ART DOCUMENT

### Patent Document

Patent document 1: DE 10 2005 047 234 A1

### SUMMARY OF THE INVENTION

### Problem to be Solved by the Invention

In recent years, the high-pressure pump is required to boost a pressure of fuel in a short time. In order to meet the request to boost the pressure in a short time, a roller bearing serving as a component of a pump tappet is required to withstand high speed, that is, high-speed rotation. Here, regarding the full-roller type bearing disclosed in the patent document 1, a roller position in the bearing is not stable and roller skew is generated at the time of high-speed rotation. Due to this roller skew, the roller pushes the roller bearing in a lateral direction, that is, an axial direction of the shaft 109, or a direction vertical to a sheet surface in FIG. 24. When the roller bearing laterally slides, a lubrication failure could be generated at an end of the roller bearing between the outer ring 108 and the case (push rod housing 102), and the outer ring 108 could be abraded.

It is an object of the present invention to provide a pump tappet which can prevent a lubrication failure of a roller bearing, and abrasion of the roller bearing at the time of high-speed rotation.

### Means for Solving the Problem

A pump tappet according to the present invention transmits a rotation movement of a cam shaft provided with a cam to a pump plunger as a reciprocation linear movement, and performs a reciprocation linear movement together with the pump plunger. The pump tappet includes a shaft, a roller bearing arranged on an outer diameter side of the shaft and rotatably supported on the shaft, and a case to house the shaft and the roller bearing. The roller bearing includes an outer ring abutting on the cam, a plurality of rollers arranged between the outer ring and the shaft, and a retainer to retain the plurality of rollers.

According to this configuration, in the roller bearing serving as the component of the pump tappet, a roller position can be stabilized by the retainer in the roller bearing at the time of high-speed rotation. In this case, the roller skew is prevented and the lateral sliding of the roller bearing can be prevented. Therefore, the lubrication failure of the roller bearing and the abrasion of the outer ring in the roller bearing can be prevented at the time of high-speed rotation.

The retainer includes a pair of annular parts, and a plurality of column parts to connect the pair of annular parts so as to form pockets to house the rollers. This retainer can house and retain the rollers in the pockets formed by the pair of annular parts and the plurality of column parts, so that the roller position in the roller bearing can be more surely stabilized at the time of high-speed rotation.

Preferably, at least one of the roller and the shaft has a nitrogen enrichment layer, the grain size number of its austenite crystal grain size exceeds 10, and its residual austenite amount is 11% by volume to 25% by volume, and its nitrogen content is 0.1% by weight to 0.5% by weight.

Since the roller bearing has the retainer, the number of rollers is reduced as compared with the full-roller type bearing. However, in this configuration, the life can be extended. In addition, the roller and the shaft can be produced by a method which will be described below.

The above austenite crystal grain size may be found by a normal method defined in JIS, or may be found by calculating an average grain diameter corresponding to the above crystal grain size number by a section method. In addition, the austenite crystal grain is not changed in a surface layer part having the nitrogen enrichment layer and not changed in its inside. Therefore, the target position of the range of the above crystal grain size number includes the surface layer part and its inside. Here, the austenite crystal grain means an austenite crystal grain whose phase has been transformed during the quenching treatment, and remains as a past history after transformed to martensite by cooling.

The residual austenite amount is a value obtained at 50 μm in the surface layer of the rolling surface after ground, and can be measured by comparing a diffraction intensity of martensite α (211) with that of residual austenite γ (220) by X-ray diffraction method. Alternatively, it can be also measured by finding a magnetization force with a magnetic scale, using the fact that an austenite phase is a nonmagnetic body, and a ferrite phase is a ferromagnetic body. Still alternatively, it can be easily measured by a commercially available measurement device.

The nitrogen enrichment layer is a layer formed in the surface layer having a large content amount of nitride, and can be formed by a treatment such as a nitrocarburizing treatment, nitriding treatment, or nitriding-quenching treatment. A nitrogen content of the nitrogen enrichment layer is a value obtained at 50 μm in the surface layer of the rolling surface after ground, and can be measured by a wavelength dispersive X-ray micro-analyzer or EPMA (Electron Probe Micro-Analysis).

The shaft has a nitrogen enrichment layer, the grain size number of its austenite crystal grain size exceeds 11, and its residual austenite amount is 10% by volume to 50% by volume. The roller may have a nitrogen enrichment layer, the grain size number of its austenite crystal grain size may exceed 10, and its residual austenite amount may be 11% by volume to 25% by volume. In this configuration also, the life of the bearing can be extended. In addition, the shaft also can be produced by the method which will be described below.

In addition, the roller may be subjected to a nitrocarburizing treatment. In this configuration also, the life of the roller bearing can be extended.

Further preferably, the retainer is provided with an oil trench recessed from its surface to inner side. Thus, an oil keeping property in the roller bearing can be improved, and abrasion of the retainer can be prevented.

The retainer may be a type of an outer diameter guide, and the oil trench may be provided in an outer diameter surface of the retainer. Thus, the retainer and the outer ring are in contact with each other, so that the radial position of the retainer can be stabilized. In addition, the lubricating property can be improved between the outer diameter surface of the retainer and the inner diameter surface of the outer ring, so that the abrasion can be prevented from being generated between the retainer and the outer ring. Therefore, the lives of the retainer and the outer ring can be extended.

In addition, the retainer may be a type of an inner diameter guide, and the oil trench may be provided in an inner diameter surface of the retainer. Thus, since the retainer and the shaft are in contact with each other, so that the radial position of the retainer can be stabilized. In addition, a lubricating property can be improved between the inner diameter surface of the retainer and the outer diameter surface of the shaft, so that the abrasion can be prevented from being generated between the retainer and the shaft. Therefore, the lives of the retainer and the shaft can be extended.

Furthermore, the retainer may be formed of a resin. Since the above retainer is relatively light in weight, the pump tappet can be light in weight as a whole, so that the pump tappet can effectively perform the reciprocation linear movement. In addition, since the resin retainer can be easily mass-produced by injection molding, it can be produced at low cost.

Further preferably, a filling rate of the roller on a roller pitch circle of the roller bearing is 50% to 90%. Since the filling rate of the rollers is set to 50% or more, the load capacity of the roller bearing can be ensured, and the life of the bearing can be extended. In addition, since the filling rate of the rollers is 90% or less, the circumferential length of the column part disposed between the rollers can be ensured, and the strength of the column part can be ensured.

In addition, with a view to ensuring the load capacity of the roller bearing and the strength of the column part, it is preferable that a length of a circumferential shortest part of the column part is 0.15 to 0.5 time as long as a diameter of the roller.

Further preferably, a circumferential space dimension between a side wall surface of the column part positioned on each circumferential side of the pocket and the roller housed in the pocket is 20 to 200 μm.

Thus, the roller skew in the pocket can be prevented, and the distance between the side wall surface of the column part and the rolling surface of the roller can be appropriately provided, so that the stable roller rolling can be ensured.

Further preferably, the outer ring is provided with a plurality of fine recessed dents in an outer diameter surface, and a surface roughness parameter Ryni of the surface with dents (average value of maximum height per reference length) is within a range of 0.8 to 2.3 μm. In this configuration, even when the outer ring and the cam are in contact with each other while they are rotating, an oil film provided between the outer ring and the cam can be prevented from being cut even under a thin lubrication atmosphere. Therefore, defective abrasion between the outer ring and the cam can be prevented, and lives of them can be extended.

Further preferably, the case is provided with a plurality of fine recessed dents in an outer diameter surface, and a surface roughness parameter Ryni of the surface with dents (average value of maximum height per reference length) is within a range of 0.8 to 2.3 μm.

At the time of operation of the pump tappet, the outer diameter surface of the case is in contact with an inner diameter surface of an opening hole provided in an engine body, but in this configuration, the oil film can be appropriately formed in the contact part between the case and the opening hole even at the time of high-speed rotation. Thus, the oil film in the contact part can be prevented from being cut. Therefore, defective abrasion can be prevented between the outer diameter surface of the case and the inner diameter surface of the opening, so that the life of the pump tappet can be extended.

Here, the surface roughness parameter Ryni is a average value of maximum height per reference length, that is, a value provided by extracting a roughness curve only with respect to a reference length in its average line direction, and measuring a distance between a peak and a valley of the extracted part in the direction of vertical magnification of the roughness curve (ISO4287:1997).

Further preferably, the case is provided with a crowning in an outer diameter surface. While the tappet performs the reciprocation linear movement in the opening hole, the case of the tappet is sometimes inclined to some extent during the reciprocation linear movement. Here, even when the case is inclined to some extent during the reciprocation linear movement, a contact stress caused by a contact between an end part of the case and the inner diameter surface of the opening hole can be lowered by the crowning provided in the outer diameter surface of the case. In addition, since a center part of the outer diameter surface of the case has a shape expanding outward as compared with the end part of the outer diameter surface due to the crowning, a small space is provided between the outer diameter surface of the case and the inner diameter surface of the opening hole on the side of the end part of the case, and the lubricant oil is likely to flow in through the space. In this case, the lubricant oil can be easily supplied between the outer diameter surface of the case and the inner diameter surface of the opening hole, so that the contact can be smoothed between the outer diameter surface of the case and the inner diameter surface of the opening hole. Therefore, defective abrasion can be prevented between the outer diameter surface of the case and the inner diameter surface of the opening hole, so the life of the tappet can be extended.

Here, the case (push rod housing 102) which is included in the tappet (roller push rod 101) and houses the roller bearing (push rod roller 103) has a cylindrical outer shape, and has a circumferential wall serving as the cylindrical part, and a middle bottom to vertically separate the space in the cylindrical part. At the time of operation of the tappet, the middle bottom abuts on one end of the pump plunger 107, and at the time of high-speed rotation, the load is frequently applied from the pump plunger to the middle bottom. In this case, when the durability of the middle bottom is low, the life of the pump tappet could be shortened.

However, in the above configuration, the rigidity of the middle bottom can be higher than that of the circumferential wall in the case, so that the durability of the middle bottom can be improved. In this case, even when the load is frequently applied from the pump plunger, its durability can be ensured for a long period of time. Therefore, the life of the tappet can be extended.

Further preferably, the middle bottom is provided with an oil hole penetrating in a thickness direction. Thus, the lubricant oil can vertically lubricate the space separated by the middle bottom, so that an oil passing property in the pump tappet can be improved.

Further preferably, the oil hole is provided in a position different from an abutment position between the middle bottom and the pump plunger. Thus, the rigidity of the part abutting on the pump plunger can be kept high in the middle bottom.

Further preferably, the oil hole is provided outside a circle provided around a radial center of the circumferential wall and having a diameter as long as 50% of an inner diameter of the circumferential wall, in the middle bottom. Since the pump plunger preferably abuts on a center part of the middle bottom, in this configuration, the oil hole can be more surely provided away from the abutment part of the pump plunger.

Further preferably, the diameter of the oil hole is as long as 20% or less of the inner diameter of the circumferential wall. Thus, the rigidity of the middle bottom can be prevented from being lowered due to the oil hole.

Further preferably, three or more of the oil holes are provided. Thus, even when the pump tappet is inclined, the lubricant oil can be more surely lubricated.

Further preferably, the case is made of a material containing 0.15 to 0.7% by weight of carbon.

As described above, the tappet (roller push rod 101) houses the roller bearing (push rod roller 103), and includes the case (push rod housing 102) which abuts on the pump plunger 107. While the tappet performs the reciprocation linear movement at the time of operation, in the case where the durability of the case is lowered, and the reciprocation linear movement is performed under a high load, the life of the case could be shortened, and accordingly the life of the tappet could be shortened. Especially under the high-speed rotation, the above problem becomes conspicuous. In addition, the case is required to have preferable processability.

However, in the above configuration, while the preferable processability of the case is maintained, the case can become high in rigidity by the heat treatment, and the durability of the case can be improved. Therefore, even at the high-speed rotation, the case can be used for a long period of time, and the life of the pump tappet can be extended.

Further preferably, the case is subjected to either one of a carburizing treatment and a nitrocarburizing treatment.

Thus, since the case is subjected to either one of the carburizing treatment and the nitrocarburizing treatment, the case can become high in rigidity, and the durability of the case can be improved. Therefore, even at the time of high-speed rotation, the case can be used for a long period of time, and the life of the pump tappet can be extended.

In addition, the case may be made of aluminum. At the time of operation of the pump tappet, the case included in the pump tappet performs the reciprocation linear movement in the vertical direction. Here, when the case is made of aluminum, the case can be relatively light in weight, so that the load due to the reciprocation linear movement can be reduced.

Meanwhile, the case may be formed of a resin. At the time of operation of the pump tappet, the case included in the pump tappet performs the reciprocation linear movement in the vertical direction as described above. Here, when the case is made of the resin, the case can be relatively light in weight, so that the load due to the reciprocation linear movement can be reduced.

Further preferably, the case is provided with a recessed part in an outer diameter surface, and a column-shaped positioning pin to position the case is fitted to the recessed part in such a manner that it partially protrudes from the outer diameter surface.

According to the patent document 1, the push rod housing 102 serving as the case regulates its circumferential rotation by a guide pin 111. Here, according to the patent document 1, the guide pin 111 is in the form of a mushroom in its cross-section. Since the above guide pin 111 has the complicated form, it cannot be easily produced. In this case, the pump tappet cannot be produced at low cost.

It is another object of the present invention to provide a pump tappet which can be produced at low cost.

Here, since the positioning pin to position the case is in the form of the column, its outer form is simple and can be easily produced. Therefore, the pump tappet including the above positioning pin can be produced at low cost.

Further preferably, the recessed part has a shape recessed from the outer diameter surface of the case so as to follow an outer diameter surface of the positioning pin. Thus, the outer diameter of the positioning pin coincides with the recessed part of the case, so that the positioning pin and the recessed part can be more surely fitted.

Further preferably, the positioning pin is pressed and fixed to the recessed part. Thus, the positioning pin can be considerably prevented from escaping from the recessed part provided in the case.

Further preferably, the plurality of recessed parts and the plurality of positioning pins are provided. Thus, the circumferential movement of the pump tappet can be more surely and more appropriately regulated.

### EFFECT OF THE INVENTION

Regarding the pump tappet according to the present invention, the roller position in the roller bearing can be stabilized by the retainer at the time of high-speed rotation, in the roller bearing serving as the component of the pump tappet. Thus, the roller skew is prevented, and the roller bearing is prevented from laterally sliding. Therefore, a lubrication failure can be prevented in the roller bearing and abrasion of the roller bearing can be prevented at the time of high-speed rotation.

### BRIEF DESCRIPTION OF DRAWINGS

FIG. 1 is a cross-sectional view showing a part of a high-pressure pump including a tappet according to one embodiment of the present invention.

FIG. 2 is a cross-sectional view of the tappet included in the high-pressure pump shown in FIG. 1.

FIG. 3 is a cross-sectional view of the tappet included in the high-pressure pump shown in FIG. 1.

FIG. 4 is a perspective view of the tappet shown in FIGS. 2 and 3.

FIG. 5 is a view of the tappet shown in FIG. 4 taken from an arrow V in FIG. 4.

FIG. 6 is a view of the tappet shown in FIG. 4 taken from an arrow VI in FIG. 4.

FIG. 7 is a view of the tappet shown in FIG. 4 taken from an arrow VII in FIG. 4.

FIG. 8 is a view of the tappet shown in FIG. 4 taken from an arrow VIII in FIG. 4.

FIG. 9 is a perspective view of a positioning pin.

FIG. 10 is a view showing a fitted state of the positioning pin and corresponds to a part of a cross-section taken along a line X-X in FIG. 6.

FIG. 11 is an enlarged view of a part shown by XI of the tappet shown in FIG. 2.

FIG. 12 is a view of a part of a roller bearing included in the tappet shown in FIG. 2 taken from an arrow XII in FIG. 11.

FIG. 13 is a cross-sectional view of a part of the roller bearing included in the tappet shown in FIG. 2 taken along a line XIII-XIII in FIG. 11.

FIG. 14 is a view to explain a two-stage heat treatment method.

FIG. 15 is a view to explain a variation of a two-stage heat treatment method.

FIG. 16 is a view showing a microstructure and, especially, austenite grains in a tappet component member subjected to a heat treatment pattern shown in FIG. 14.

FIG. 17 is a view showing a microstructure, especially, an austenite grains in a conventional tappet component member.

FIG. 18 is a schematic view of the microstructure shown in FIG. 16 and shows illustrated austenite grains.

FIG. 19 is a schematic view of the microstructure shown in FIG. 17 and shows illustrated austenite grains.

FIG. 20 is a view showing schematic production steps of the member, including a high-frequency quenching.

FIG. 21 is a view to explain one example of the heat treatment method including the high-frequency quenching.

FIG. 22 is a view showing a fitted state of a positioning pin included in a tappet according to another embodiment of the present invention, and corresponds to the part in FIG. 10.

FIG. 23 is a schematic perspective view showing a part of a tappet according to still another embodiment of the present invention, and corresponds to the part in FIG. 4.

FIG. 24 is a cross-sectional view showing a conventional tappet serving as a roller push rod.

### BEST MODE FOR CARRYING OUT THE INVENTION

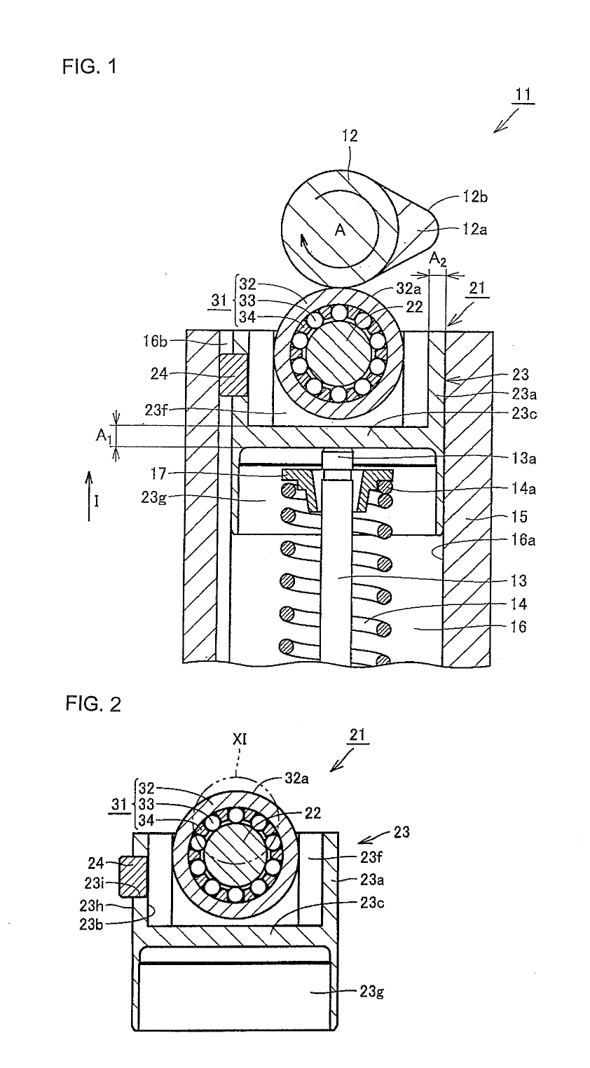

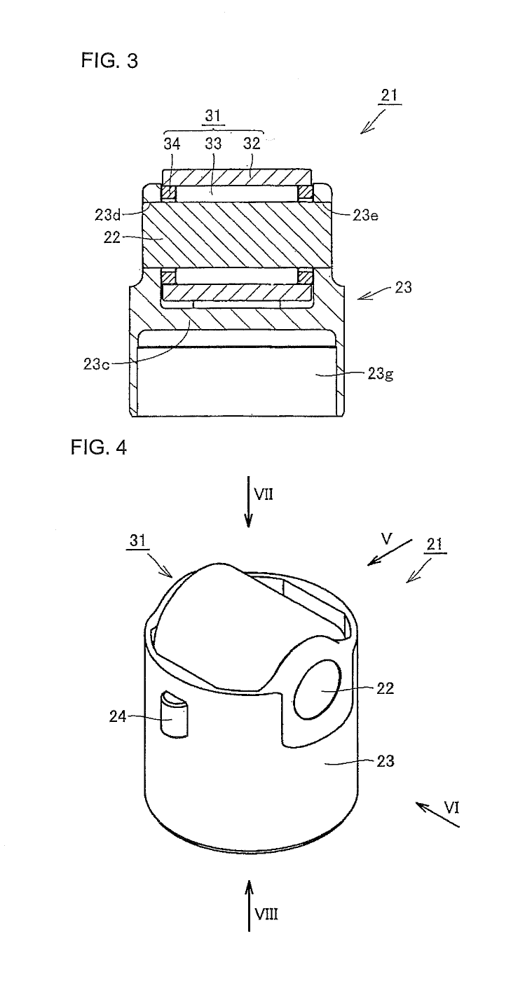

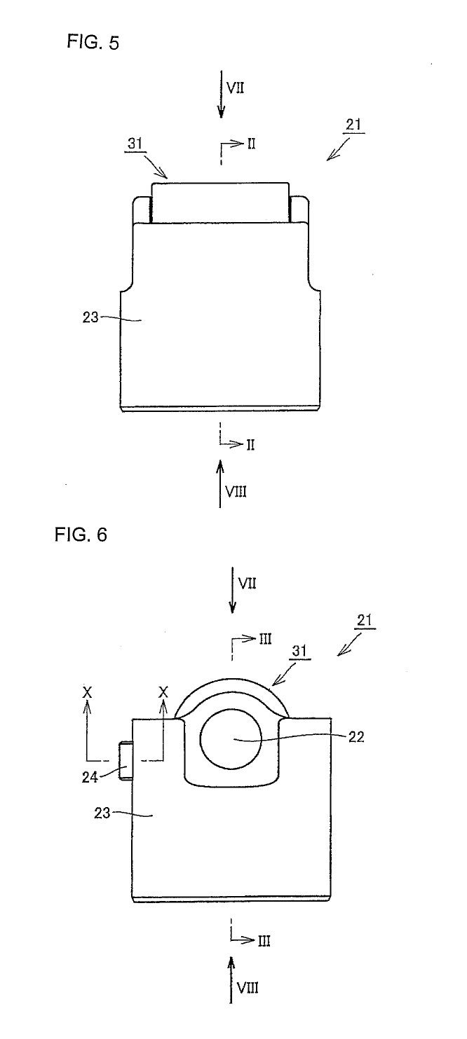

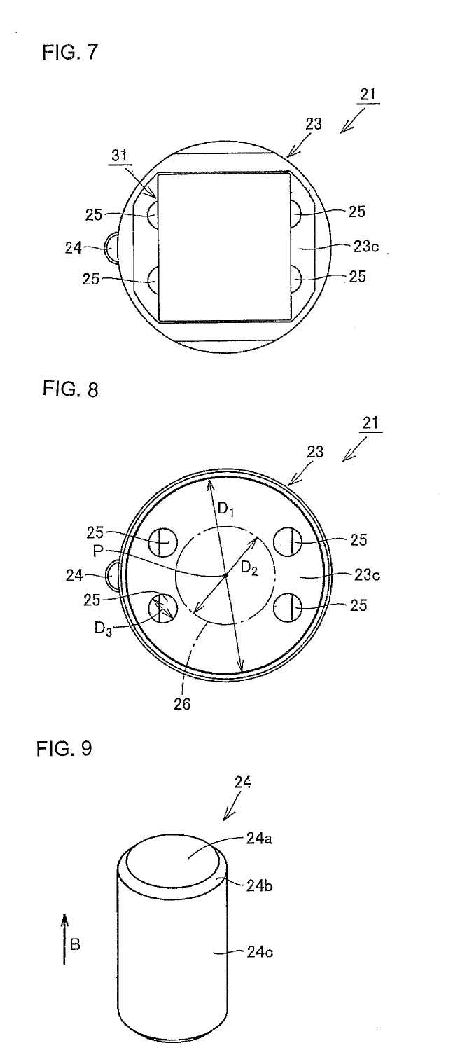

Hereinafter, an embodiment of the present invention will be described with reference to the drawings. FIG. 1 is a cross-sectional view showing a part of a high-pressure pump including a pump tappet according to one embodiment of the present invention (hereinafter, referred to as the “tappet” simply). FIGS. 2 and 3 are cross-sectional views of the tappet included in the high-pressure pump shown in FIG. 1. FIG. 4 is a schematic perspective view of the tappet shown in FIGS. 2 and 3. FIG. 5 is a view of the tappet in FIG. 4 taken from an arrow V in FIG. 4. FIG. 6 is a view of the tappet in FIG. 4 taken from an arrow VI in FIG. 4. FIG. 7 is a view of the tappet in FIG. 4 taken from an arrow VII in FIG. 4. FIG. 8 is a view of the tappet in FIG. 4 taken from an arrow VIII in FIG. 4. In addition, FIG. 2 corresponds to a cross-section taken along a line II-II in FIG. 5, and FIG. 3 corresponds to a cross-section taken along a line III-III in FIG. 6. In addition, in the following drawings, hatching for the cross-section of the roller is omitted to be easily understood.

First, a configuration of the high-pressure pump including the tappet according to one embodiment of the present invention will be described with reference to FIGS. 1 to 8. A high-pressure pump 11 including the tappet according to one embodiment of the present invention includes a cam shaft 12 having a cam 12a on its outer diameter side, to perform a rotation movement in a direction shown by an arrow A in FIG. 1, a tappet 21 abutting on the cam 12a, to transmit the rotation movement of the cam shaft 12 to a pump plunger 13 (hereinafter, referred to as the “plunger” simply) as a reciprocation linear movement, and to perform a reciprocation linear movement, the plunger 13 serving as a rod-shaped member abutting on the tappet 21, to perform a reciprocation linear movement, a high-pressure chamber (not shown) to boost a pressure of gas supplied according to the reciprocation linear movement of the plunger 13, a spring 14 abutting on the tappet 21 and provided so as to arrange the plunger 13 on its inner side, and an engine body 15 to house the plunger 13 and the spring 14.

The tappet 21, the plunger 13, and the spring 14 are arranged so as to be housed in an opening hole 16 provided in the engine body 15. The tappet 21 is guided in a vertical direction in FIG. 1, that is, a direction shown by an arrow I in FIG. 1 and an opposite direction thereof, along an inner diameter surface 16a of the opening hole 16.

The cam shaft 12 and the tappet 21 are arranged in such a manner that an outer diameter surface 12b of the cam 12a abuts on an outer diameter surface 32a of an outer ring 32 provided in a roller bearing 31 included in the tappet 21. One end 13a of the plunger 13 is arranged so as to abut on a middle bottom 23c provided in a case 23 included in the tappet 21. The spring 14 is arranged such that its one end 14a abuts on a spring washer 17 provided on the lower side of the middle bottom 23c.

The spring 14 has elastic force in a downward direction, that is, the direction opposite to the direction shown by the arrow I in FIG. 1. The tappet 21 is forced in an upward direction, that is, the direction shown by the arrow I in FIG. 1, by the elastic force of the spring 14 through the plunger 13.

The tappet 21 and the plunger 13 perform the reciprocation linear movement in the vertical direction, that is, in the direction shown by the arrow I in FIG. 1 and its opposite direction, by the rotation movement of the cam shaft 12, the force of the spring 14, and the guide of the inner diameter surface 16a of the opening hole 16. Here, the reciprocation linear movement means a movement in the direction shown by the arrow I in FIG. 1 and its opposite direction. The tappet 21 performs the reciprocation linear movement in the direction shown by the arrow I in FIG. 1 and its opposite direction while being inclined to some extent. When the cam shaft 12 rotates at high speed, speed of the reciprocation linear movements of the tappet 21 and the plunger 13 is also fast.

The high-pressure chamber is arranged on the other end side (not shown) of the plunger 13. The pressure to a fuel supplied in the high-pressure chamber can be boosted by the reciprocation linear movement of the plunger 13.

Next, a description will be made of a configuration of the tappet 21 according to one embodiment of the present invention. The tappet 21 includes a shaft 22, the roller bearing 31 arranged on the outer diameter side of the shaft 21, and rotatably supported around the shaft 22, and the case 23 to house the shaft 22 and the roller bearing 31.

The case 23 includes a cylindrical circumferential wall 23a, and the middle bottom 23c provided in a middle position of an inner diameter surface 23b of the circumferential wall 23a so as to separate the space in the vertical direction. The middle bottom 23c of the case 23 abuts on the plunger 13.

Here, a thickness of the middle bottom 23c is set so as to be larger than that of the circumferential wall 23a. More specifically, when it is assumed that the thickness of the middle bottom 23c is A₁, and the thickness of the circumferential wall 23a is A₂ shown in FIG. 1, they are set such that A₁>A₂. Thus, rigidity of the middle bottom 23c is higher than that of the circumferential wall 23a of the case 23, and durability of the middle bottom 23c can be improved. In this case, even when the load is frequently applied from the plunger 13 at the time of high-speed rotation, it can endure for a long period of time. Therefore, the life of the tappet 21 can be extended.

A pair of support holes 23d and 23e is provided on one end side of the circumferential wall 23a to support the shaft 22. The shaft 22 is arranged such that the shaft 22 is inserted into the pair of support holes 23d and 23e. The roller bearing 31 is arranged on the outer diameter side of the shaft 22. Thus, the case 23 house the shaft 22 and the roller bearing 31 in a space 23f provided from the middle bottom 23c to the one end side of the circumferential wall 23a.

A part of the plunger 13 is housed in a space 23g provided from the middle bottom 23c to the other end side of the circumferential wall 23a. More specifically, the one end 13a of the plunger 13 is housed such that the one end 13a of the plunger 13 is arranged so as to abut on a radial center part of the middle bottom 23c. In addition, one end 14a of the spring 14 is also housed in the space 23g.

Four oil holes 25 are provided in the middle bottom 23c so as to penetrate its thickness direction (refer to FIGS. 7 and 8). The four oil holes 25 are arranged so as not to be provided at the abutment part between the one end 13a of the plunger 13 and the middle bottom 23c. By use of these oil holes 25, a lubricant oil which is supplied to the tappet 21 can pass between the space 23f and the space 23g. That is, due to the four oil holes 25, an oil passing property can be improved in the case 23. In addition, by providing as many as four oil holes 25, the oil passing property can be more effectively improved.

In addition, since they are provided away from the abutment part between the one end 13a of the plunger 13 and the middle bottom 23c, a part on which the plunger 13 abuts, in the middle bottom 23c can be kept high in rigidity. That is, although the rigidity of the part having the oil hole 25 is a little lower than that of the part having no oil hole 25, the load from the plunger 13 can be received by the part having relatively high rigidity because the oil holes are provided away from that part, so that the case 23, and thus the tappet 21 can be improved in durability.

While the four oil holes are provided here, it is preferable that three or more oil holes are provided. In this case, as the tappet 21 performs the reciprocation linear movement while being inclined to some extent as described above, by providing the three or more oil holes 25, the lubricant oil can pass through any one of the oil holes 25 even when the tappet 21 is inclined in a certain direction. Therefore, the oil passing property can be more surely ensured.

In addition, the oil holes 25 are preferably provided outside a circle 26 having a center P which is the radial center of the circumferential wall 23a and a diameter D₂ which is as long as 50% of an inner diameter D₁ of the circumferential wall 23a, in the middle bottom 23c as shown by a one-dot chain line (refer to FIG. 8). Thus, the oil holes 25 can be surely provided away from the abutment part of the plunger 13.

In addition, a diameter D₃ of the oil hole 25 is preferably as long as 20% or less of the inner diameter D₁ of the circumferential wall 23a. Thus, the rigidity of the middle bottom 23c is prevented from being lowered by the oil holes 25.

Here, a plurality of fine recessed dents are provided in an outer diameter surface 23h of the case 23, and a surface roughness parameter Ryni of the surface with the dents is 0.8 to 2.3 μm.

Since the outer diameter surface 23h of the case 23 is brought into contact with the inner diameter surface 16a of the opening hole 16 provided in the engine body 15 at the time of the rotation movement of the cam shaft 12, that is, at the time of the operation of the tappet 21, by providing the above configuration, that is, by providing the plurality of fine recessed dents in the outer diameter surface 23h of the case 23 and setting the surface roughness parameter Ryni of the surface with the dents to 0.8 to 2.3 μm, an oil film can be appropriately formed between a contact part between the case 23 and the opening hole 16 at the time of high-speed rotation. Thus, the oil film is prevented from being cut in the contact part. Therefore, defective abrasion between the outer diameter surface 23h of the case 23 and the inner diameter surface 16a of the opening hole 16 can be prevented, and the life of the tappet 21 can be extended.

In addition, a surface roughness parameter Sk (skewness of roughness curve) of the surface with the dents may be −1.6 or less. When the surface roughness parameter Sk value is defined within the above range, a recessed part for storing the lubricant oil can be defined within an effective range, so that a formed oil film thickness is ensured and the oil film can be appropriately formed. Here, the surface roughness parameter Sk value means the skewness of a roughness curve (ISO4287:1997), which is a statistic as a measure to know asymmetry of a concavo-convex distribution, and the Sk value is close to 0 in a symmetric distribution such as a gause distribution, and it shows a negative value in a case where the convex part is removed and shows a positive value in the opposite case.

In addition, a surface roughness parameter Rymax (maximum value of maximum height per reference length) of the surface with dents may be set within a range of 0.4 to 1.0 μm. The surface roughness parameter Rymax is a maximum value of maximum height per reference length (ISO4287:1997). By defining the surface roughness parameter Rymax to such range, the oil film can be appropriately formed.

In addition, a surface roughness parameter Rqni (root mean square roughness) of the surface with dents may be set within a range of 0.13 to 0.5 μm. The surface roughness parameter Rqni is a square root of a value provided by integrating the square of deviation of height from a roughness center line to a roughness curve with respect to a section of a measurement length, and averaging the value in that section (ISO4287:1997).

In addition, an area ratio of the dents of the surface with dents may be set to be within a range of 5 to 20%. The area ratio of the dents means a ratio of the area of the dents to the whole area of the outer diameter surface when the fine recessed dents are provided in the outer diameter surface. When the area ratio of the dents to the whole area is defined as described above, a range of the surface having a preferable lubricating property can be defined, so that the life can be extended.

In addition, a crowning may be provided in the outer diameter surface 23h of the case 23. While the tappet 21 performs the reciprocation linear movement in the opening hole 16, the case 23 of the tappet 21 is sometimes inclined to some extent during the reciprocation linear movement. Here, even when the case 23 is inclined to some extent during the reciprocation linear movement, a contact stress caused by a contact between an end part 23j of the outer diameter surface 23h of the case 23 and the inner diameter surface 16a of the opening hole 16 can be lowered by the crowning provided in the outer diameter surface 23h of the case 23. In addition, since a center part 23k of the outer diameter surface 23h of the case 23 expands outward as compared with the end part 23j of the outer diameter surface 23h of the case 23 due to the crowning, a small space is provided between the outer diameter surface 23h of the case 23 and the inner diameter surface 16a of the opening hole 16 on the side of the end part 23j of the outer diameter surface 23h of the case 23, and the lubricant oil is likely to flow in through the space. In this case, the lubricant oil can be easily supplied between the outer diameter surface 23h of the case 23 and the inner diameter surface 16a of the opening hole 16, so that the contact can be smoothed between the outer diameter surface 23h of the case 23 and the inner diameter surface 16a of the opening hole 16. Therefore, defective abrasion can be prevented between the outer diameter surface 23h of the case 23 and the inner diameter surface 16a of the opening hole 16, so the life of the tappet 21 can be extended.

Here, the crowning means a shape in which the side of the center part 23k of the outer diameter surface 23h of the case 23 expands toward the outer diameter side as compared with the side of the end part 23j of the outer diameter surface 23h of the case 23. The crowning may be a full-crowning or may be a partial crowning or a cut-crowning. In addition, since the crowning provided in the outer diameter surface 23h is very small, it is not shown in the drawing.

Here, a carbon content of a used material of the case 23 is 0.15 to 0.7% by weight. When the carbon content is less than 0.15%, it is difficult to enhance hardness in a heat treatment. Meanwhile, when the carbon content is more than 0.7%, it is difficult to perform a forming process of the case 23, more specifically, a process to generate plastic deformation in a pressing process or casting of the case 23. However, in the above configuration, while the preferable processability of the case 23 is maintained, the case 23 can become high in rigidity by the heat treatment, and the durability of the case 23 can be improved. Therefore, under the high-speed rotation, the case 23 can be surely used for a long period of time, and the life of the tappet 21 can be extended.

In addition, a specific material for the case 23 includes SCM415 or S50C (each is defined in JIS) containing 0.15 to 0.5% by weight of carbon.

It is preferable that the case is subjected to either one of a carburizing treatment or a nitrocarburizing treatment. The case 23 can surely show high rigidity through that heat treatment.

In addition, while the carburizing treatment or the nitrocarburizing treatment is performed in the above embodiment, the present invention is not limited to this, and as a quenching treatment, a bright quenching or a high-frequency quenching treatment may be employed.

In addition, the case 23 may be formed of aluminum. At the time of the operation of the tappet 21, the case 23 included in the tappet 21 performs the reciprocation linear movement in the vertical direction. Here, when the case 23 is formed of aluminum, the case 23 can be relatively light in weight, so that the load due to the reciprocation linear movement can be reduced.

In addition, the case 23 may be formed of a resin. The case 23 included in the tappet 21 performs the reciprocation linear movement in the vertical direction at the time of the operation of the tappet 21 as described above. Thus, when the case 23 is formed of the resin, the case 23 can be relatively light in weight, so that the load due to the reciprocation linear movement can be reduced. In this case, a specific material of the case 23 includes polyphenylene sulfide (PPS) and polyether ether ketone (PEEK). In addition, with a view to implementing high rigidity, carbon fiber, glass fiber, or carbon black may be added to the resin when it is needed.

The case 23 has a through hole 23i serving as a recessed part which penetrates from the outer diameter surface 23h to the inner diameter surface 23b of the circumferential wall 23a. A positioning pin 24 is fitted to the through hole 23i in such a manner that it partially projects from the outer diameter surface 23h. The positioning pin 24 is provided to position the tappet 21 disposed in the opening hole 16. That is, the tappet 21 includes the positioning pin 24 to position the case 23. In addition, as for the positioning of the case 23, it will be described below.

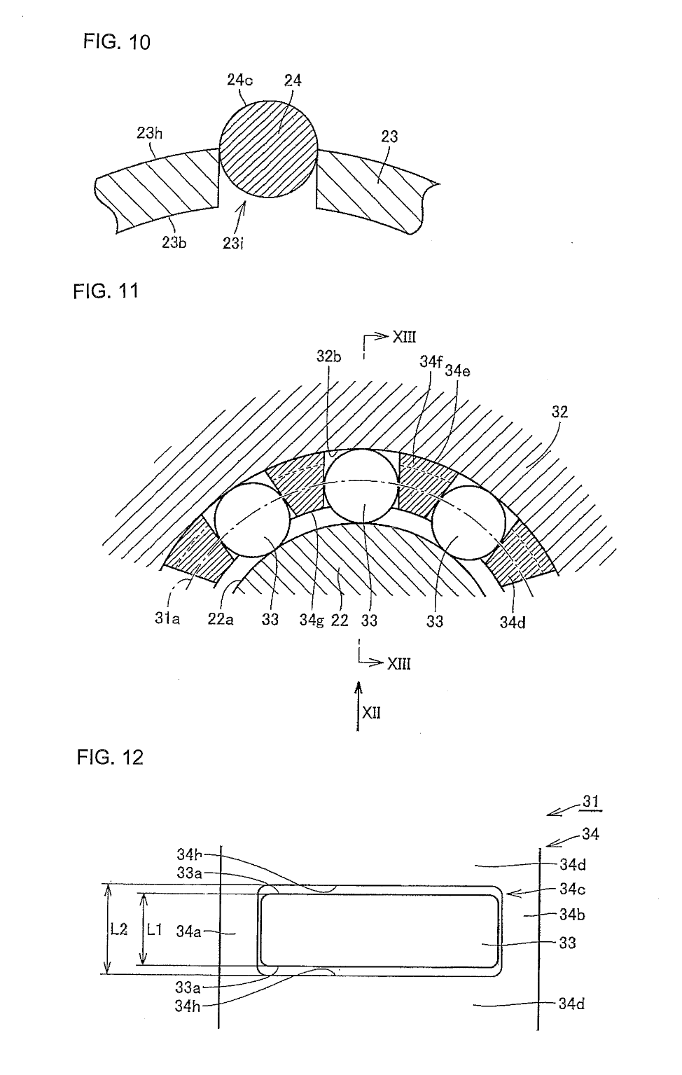

FIG. 9 is a perspective view of the positioning pin 24. FIG. 10 is a view showing a fitted state of the positioning pin 24, and corresponds to a part of a cross-section taken along a line X-X in FIG. 6. Referring to FIGS. 1 to 10, the positioning pin 24 is a cylindrical member extending in a direction shown by an arrow B in FIG. 9, and its outer shape in cross-section is a circle (refer to FIG. 10). In addition, this circle may not a true circle. A chamfer such as a C-chamfer or R-chamfer is provided in a corner part of an end face 24a positioned on longitudinal each end of an outer diameter surface 24c composed of a curved surface, in the positioning pin 24. Since the positioning pin 24 is in the form of a circular cylinder, its outer shape can be simple and easily produced. Therefore, the tappet 21 including the positioning pin 24 can be produced at low cost.

As described above, the positioning pin 24 is configured such that its one part projects from the outer diameter surface 23h when fitted to the through hole 23i. Here, the positioning pin 24 is pressed and fixed to the through hole 23i serving as a recessed part. Thus, the positioning pin 24 is considerably prevented from escaping from the through hole 23i provided in the case 23 as the recessed part.

A recessed trench 16b extending in the direction of the arrow I in FIG. 1 is provided in the inner diameter surface 16a of the through hole 16 of the engine body 15 so as to be recessed from the inner diameter surface 16a. When the tappet 21 is housed in the opening hole 16, the projected part of the positioning pin 24 is fitted to the recessed trench 16b. Thus, the case 23 and thus the tappet 21 can be positioned in a circumferential direction in the opening hole 16. Thus, the tappet 21 can be prevented from rotating in the circumferential direction in the opening hole 16.

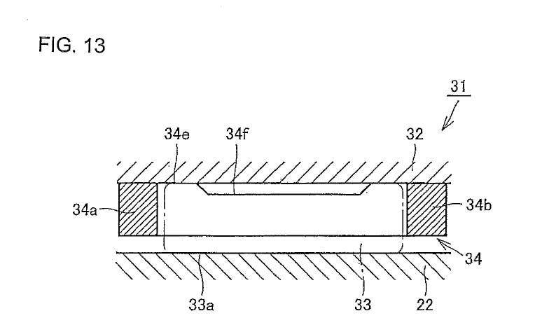

Next, a description will be made of a configuration of the roller bearing 31 included in the tappet 21. FIG. 11 is an enlarged view of a part shown by a two-dot chain line XI in FIG. 2. A roller pitch circle 31a is shown by one-dot chain line in FIG. 11. FIG. 12 is a view of a part of the roller bearing 31 taken from an arrow XII in FIG. 11. FIG. 13 is a cross-sectional view showing a part of the roller bearing 31 taken along a line XIII-XIII in FIG. 11. Referring to FIGS. 1 to 13, the roller bearing 31 includes the outer ring 32, a plurality of rollers 33 arranged between the outer ring 32 and the shaft 22, and a retainer 34 to retain the plurality of rollers 33.

The retainer 34 includes a pair of annular parts 34a and 34b, and a plurality of column parts 34d to connect the pair of annular parts 34a and 34b so as to form pockets 34c to house the rollers 33. The column part 34d has a shape extending straight in an axial direction, that is, in a vertical direction with respect to sheet surface in the cross-sectional view shown in FIG. 11.

The retainer 34 is arranged between the outer ring 32 and the shaft 22 similar to the roller 33. The plurality of rollers 33 are housed and retained in the respective pockets 34c provided in the retainer 34. The retainer 34 is guided by an outer diameter, that is, it is configured such that an inner diameter surface 32b of the outer ring 32 arranged on the outer diameter side of the retainer 34 and an outer diameter surface 34e of the retainer 34 are in contact with each other in a radial direction. In addition, an oil trench 34f is provided in the retainer 34 so as to be recessed inward from the outer diameter surface 34e. The oil trench 34f is provided in the center of the column part 34d and has a shape extending in a circumferential direction.

The outer ring 32 and the rollers 33 serving as the components of the roller bearing 31 rotate together with the rotation movement of the cam shaft 12. When the cam shaft 12 rotates at high speed, the roller 33 rotates at high speed. Here, in the roller bearing 31 serving as the component of the tappet 21, the positions of the rollers 33 can be stabled by the retainer 34 in the roller bearing 31 at the time of high-speed rotation. Thus, the roller 33 is prevented from skewing and the roller bearing 31 is prevented from laterally sliding. Therefore, a lubrication failure of the roller bearing 31, and the abrasion of the roller bearing 31 can be prevented from generating at the time of high-speed rotation. That is, the pump tappet can be produced at low cost and extends its life.

In addition, since the high-pressure pump 11 includes the tappet 21 which can prevent the lubrication failure of the roller bearing 31 and the abrasion of the roller bearing 31 at the time of high-speed rotation, it can be produced at low cost and can stably boost the pressure of the fuel in a short time.

Here, since the retainer 34 is guided by the outer diameter, and the oil trench 34f recessed inward from its surface is provided in the outer diameter surface 34e of the retainer 34, the radial position of the retainer 34 can be stabilized by the contact between the retainer 34 and the outer ring 32. In addition, an oil passing property between an inner diameter surface 34g of the retainer 34 and an outer diameter surface 22a of the shaft 22 can be improved, and a lubricating property between the outer diameter surface 34e of the retainer 34 and the inner diameter surface 32b of the outer ring 32 can be improved, and abrasion between the retainer 34 and the outer ring 32 can be prevented. Therefore, lives of the retainer 34, the roller 33, the outer ring 32, and the shaft 22 can be extended. In addition, the oil trench may be provided to extend with an axial inclination, or may be provided so extend with a curvature. In addition, the plurality of oil trenches may be provided.

In addition, the retainer 34 may be an inner guide type and an oil trench may be provided in the inner diameter surface 34g of the retainer 34. In this case, the radial position of the retainer 34 can be stabilized by the contact between the retainer 34 and the shaft 22. In addition, a oil passing property between the outer diameter surface 34e of the retainer 34 and the inner diameter surface 32b of the outer ring 32 can be improved, and a lubricating property between the inner diameter surface 34g of the retainer 34 and the outer diameter surface 22a of the shaft 22 can be improved, and abrasion between the retainer 34 and the shaft 22 can be prevented. Therefore, lives of the retainer 34, the roller 33, the outer ring 32, and the shaft 22 can be extended.

The retainer 34 in the roller bearing 31 may be formed of a resin. In this case, the retainer 34 itself can be light in weight and thus a weight of the tappet 21 can be light in total. Therefore, the force required for the reciprocation linear movement, that is, the force required for the vertical movement of the tappet 21 here can be reduced. In addition, when the retainer 34 is made of the resin, injection molding can be used, so that it can be easily mass-produced at low cost. Materials of the retainer 34 include nylon 66, nylon 46, polyphenylene sulfide (PPS), and polyether ether ketone (PEEK). In addition, carbon fiber, glass fiber, or carbon black may be added to the resin when it is needed.

A filling rate of the roller 33 in the roller bearing 31 is preferably 50% to 90% on the roller pitch circle 31a. When it is less than 50%, load capacity of the roller bearing 31 could be too small. In addition, when it is more than 90%, a circumferential length of the column part 34b positioned between the pockets 34c is too short, and strength of the column part 34d could not be sufficiently provided.

In addition, with a view to ensuring the load capacity of the roller bearing 31 and obtaining the strength of the column part 34d, a circumferential shortest length of the column part 34d is preferably 0.1 to 0.5 time as long as a diameter of the roller 33. Here, the circumferential shortest part of the column is positioned on the inner diameter side of the column part 34d.

In addition, a circumferential space dimension between a side wall surface 34h of the column part 34d positioned on circumferential each side of the pockets 34c and the roller 33 housed in the pocket 34c is preferably 20 to 200 μm. More specifically, referring to FIG. 12, when it is assumed that a diameter of the roller 33 is L₁, and the circumferential length of the pocket 34c, that is, the space between the side wall surfaces 34h of the column part 34d positioned circumferential both sides of the pocket 34c is L₂, L₂−L₁ is set to be 20 to 200 μm. Thus, the roller 33 in the pocket 34c can be prevented from skewing, and the distance between the side wall surface 34h of the column part 34d and a rolling surface 33a of the roller 33 can be appropriate, so that the roller 33 can stably rolls. In addition, in FIG. 12, the space dimension between the roller 33 housed in the pocket 34c and the side wall surface 34h of the column part 34d is exaggerated and largely shown so as to be easily understood.

In addition, the roller and the shaft serving as the component of the tappet are produced by casting, and cutting a steel member such as SUJ2 or SCM 420 (each is defined in JIS).

Furthermore, in the above embodiment, a plurality of fine recessed dents may be provided in the outer diameter surface of the outer ring. Here, as for a surface roughness parameter Ryni of dents provided in the outer diameter surface of the outer ring, the one used in the above is employed. That is, the surface roughness parameter Ryni of the surface with dents is set to 0.8 to 2.3 μm. Since the outer ring and the cam are in contact with each other while they are rotating, by setting the value as described above, an oil film provided between the outer ring and the outer diameter surface of the cam can be prevented from being cut even under a thin lubrication atmosphere. Therefore, defective abrasion between the outer ring and the cam can be prevented, and their lives can be extended.

Here, when at least one member of the roller and the shaft in the tappet is subjected to a heat treatment by a low-temperature secondary quenching method which will be described below, the grain size number of the austenite crystal grain in a nitrogen enrichment layer of at least one member of the roller and the shaft is beyond 10, a residual austenite amount thereof is 11% by volume to 25% by volume, and a nitrogen content thereof is 0.1% by weight to 0.5% by weight.

When the roller bearing has the retainer, the number of rollers of the roller bearing is less than that of a full-roller type bearing. However, when at least one member of the roller and the shaft serving as the components of the tappet is configured as described above, the rigidity can be enhanced in at least one of the roller and the shaft, so that the life of the bearing can be extended.

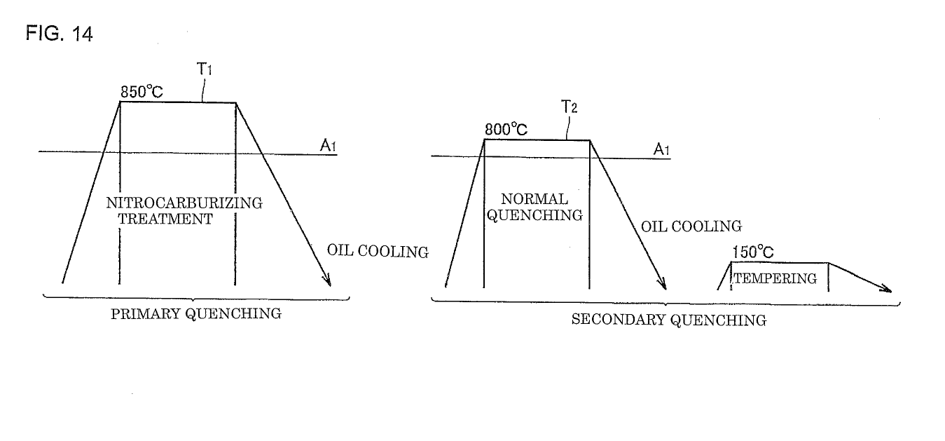

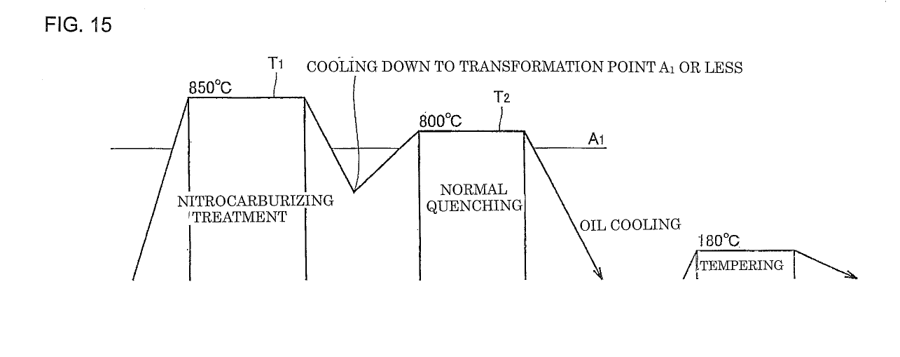

Next, a description will be made of the heat treatment including nitrocarburizing treatment subjected to at least one member of the roller and the shaft. FIG. 14 is a view to explain one example of a two-stage heat treatment method to obtain the member configured as described above. In addition, FIG. 15 is a view to explain a variation of the two-stage heat treatment method in FIG. 14. FIG. 14 is a heat treatment pattern showing a method in which primary quenching and secondary quenching are performed, and FIG. 15 is a heat treatment pattern showing a method in which a material is cooled to a transformation point A₁ or less in the middle of quenching, and heated again and quenching is performed. The above-described member can be obtained by each method. Referring to these views, in a treatment T₁, carbon or nitrogen is diffused in a steel base and carbon is sufficiently solved therein, and then cooled down to the transformation point A₁ or less. Then, in a treatment T₂ in the view, the material is reheated to a temperature lower than that in the treatment T₁, and subjected to oil quenching. In addition, the heat treatment methods shown in FIGS. 14 and 15 are collectively called the two-stage heat treatment.

By the above heat treatment, as compared with normal quenching in which quenching is performed at one time after the nitrocarburizing treatment, crack strength is improved and an aging dimensional change rate can be reduced while a surface layer part is being nitrocarburized. The above heat treatment provides a microstructure in which a grain diameter of the austenite crystal grain can be less than half of that of the conventional one. Regarding the member subjected to the above heat treatment, rolling fatigue characteristics have a long life, the crack strength is improved, and the aging dimensional change rate can be reduced.

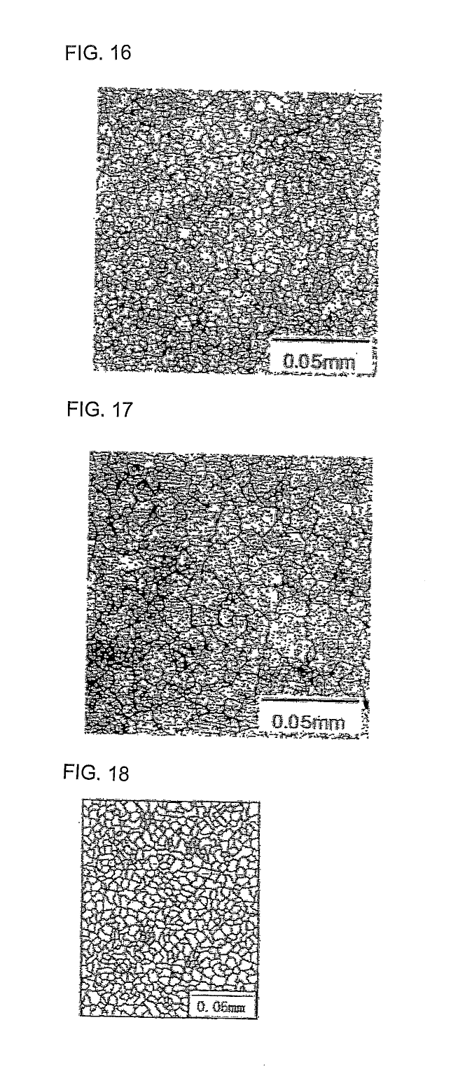

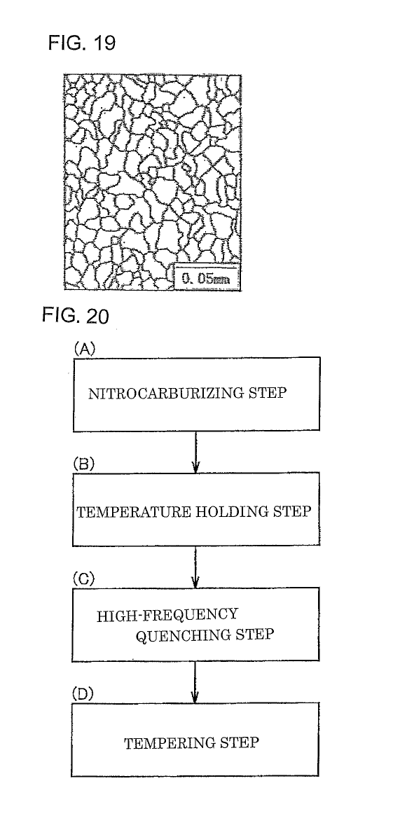

FIGS. 16 and 17 are views showing microstructures, especially the austenite grains. FIG. 16 shows a member subjected to the above heat treatment method, and FIG. 17 shows a conventional member. That is, FIG. 16 shows the austenite crystal grain size of the bearing steel to which the heat treatment pattern shown in FIG. 15 is applied. In addition, FIG. 17 shows an austenite crystal grain size of bearing steel subjected to the conventional heat treatment method for comparison. In addition, FIGS. 18 and 19 are views showing illustrated austenite crystal grain boundaries in FIGS. 16 and 17, respectively. With the structures showing the austenite crystal grain sizes, while the grain size number of the conventional austenite grain diameter is 10 or less, the one obtained by the above two-stage heat treatment method can be as fine as 12 in terms of JIS.

Thus, by performing the above two-stage heat treatment, fatigue strength can be improved in at least one member of the roller and the shaft, so that the life of the bearing can be improved.

In addition, both of the roller and the shaft may be subjected to either one of the heat treatments so as to be configured as described above.

In addition, the shaft may be configured such that it has the nitrogen enrichment layer, the grain size number of the austenite crystal grain size is beyond 11, and the residual austenite amount is 10% by volume to 50% by volume. In this configuration, load resistance of the roller bearing can be improved. In addition, the above member is produced in such a manner that it is subjected to the nitrocarburizing treatment at the transformation point A₁ or less, held for 60 to 180 minutes at a temperature lower than the transformation point A₁, and then subjected to the high-frequency quenching.

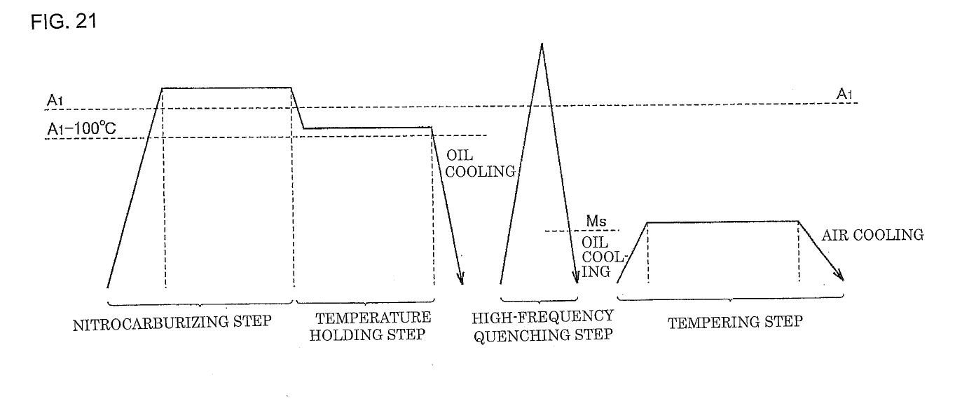

FIG. 20 is a view showing schematic production steps of the member in this case. FIG. 21 is a view to explain one example of a heat treatment method to obtain the member configured as described above. Referring to FIGS. 20 and 21, the member is subjected to the nitrocarburizing treatment at the transformation point A₁ or more (FIG. 20(A)). Then, after the nitrocarburizing treatment, the member is cooled down to a temperature lower than the transformation point A₁, and held at this temperature for 60 minutes to 180 minutes (FIG. 20(B)). Then, the member is subjected to the high-frequency quenching (FIG. 20(C)), and then subjected to a tempering treatment (FIG. 20(D)). Thus, the member is produced through the heat treatment. The member produced by the above steps has the above configuration such that it has the nitrogen enrichment layer, the grain size number of the austenite crystal grain size is beyond 11, and the residual austenite amount is 10% by volume to 50% by volume. In this configuration also, the life of the bearing can be extended.

In addition, the roller may be subjected to the nitrocarburizing treatment. In this case also, the life of the bearing can be extended.

In addition, in the above embodiment, a plurality of fine recessed dents may be provided in the outer diameter surface of the outer ring. Although the outer ring and the cam are in contact with each other while they are rotating, in this configuration, an oil film provided between the outer ring and the cam can be prevented from being cut even under a thin lubrication atmosphere. Therefore, abrasion between the outer ring and the cam can be prevented, and lives thereof can be extended.

Here, a surface roughness parameter Ryni of the surface with dents (average value of maximum height per reference length) is preferably set within a range of 0.8 to 2.3 μm. As described above, the surface roughness parameter Ryni is an average value of maximum height per reference length, that is, a value provided by extracting a roughness curve only with respect to a reference length in its average line direction, and measuring a distance between a peak and a valley of the extracted part in the direction of vertical magnification of the roughness curve (ISO4287:1997).

In addition, a surface roughness parameter Sk (skewness of roughness curve) of the surface with the dents may be −1.6 or less. When the surface roughness parameter Sk value is defined within the above range, a recessed part for storing the lubricant oil can be defined within an effective range, so that a formed oil film thickness is ensured and the oil film can be appropriately formed. Here, as described above, the surface roughness parameter Sk value means the skewness of a roughness curve (ISO4287:1997), which is a statistic as a measure to know asymmetry of a concavo-convex distribution, and the Sk value is close to 0 in a symmetric distribution such as a gause distribution, and it shows a negative value in a case where the convex part is removed and shows a positive value in the opposite case.

In addition, the surface roughness parameter Rymax (maximum value of maximum height per reference length) of the surface with dents may be set within a range of 0.4 to 1.0 μm. As described above, the surface roughness parameter Rymax is the maximum value of the maximum height per reference length (ISO4287:1997). By defining the surface roughness parameter Rymax to such range, the oil film can be appropriately formed.

In addition, a surface roughness parameter Rqni (root mean square roughness) of the surface with dents may be set within a range of 0.13 to 0.5 μm. As described above, the surface roughness parameter Rqni is a square root of a value provided by integrating the square of deviation of height from a roughness center line to a roughness curve with respect to a section of a measurement length, and averaging the value in that section (ISO4287:1997).

In addition, an area ratio of the dents of the surface with dents may be set to be within a range of 5 to 20%. As described above, the area ratio of the dents means a ratio of the area of the dents to the whole area of the outer diameter surface when the fine recessed dents are provided in the outer diameter surface. When the area ratio of the dents to the whole area is defined as described above, a range of the surface having the preferable lubricating property can be defined, so that the life can be extended.

Here, while the recessed part to which the positioning pin is fitted is a through hole penetrating from the inner diameter surface to the outer diameter surface of the case in the above embodiment, the present invention is not limited to this, and the recessed part may not penetrate from the inner diameter surface to the outer diameter surface of the case. Thus, the recessed part may have a shape recessed from the outer diameter surface of the case so as to follow the outer diameter surface of the positioning pin. In this case, the outer diameter surface of the positioning pin coincides with the recessed part of the case, so that the positioning pin and the recessed part can be more surely fitted.

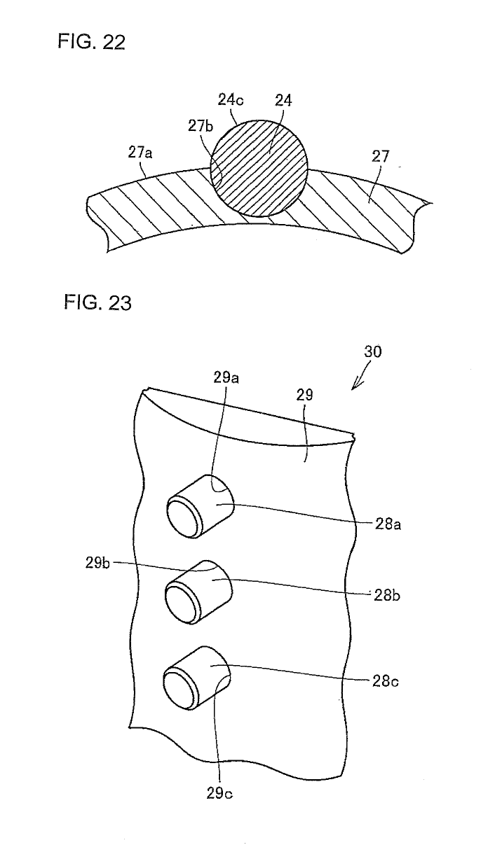

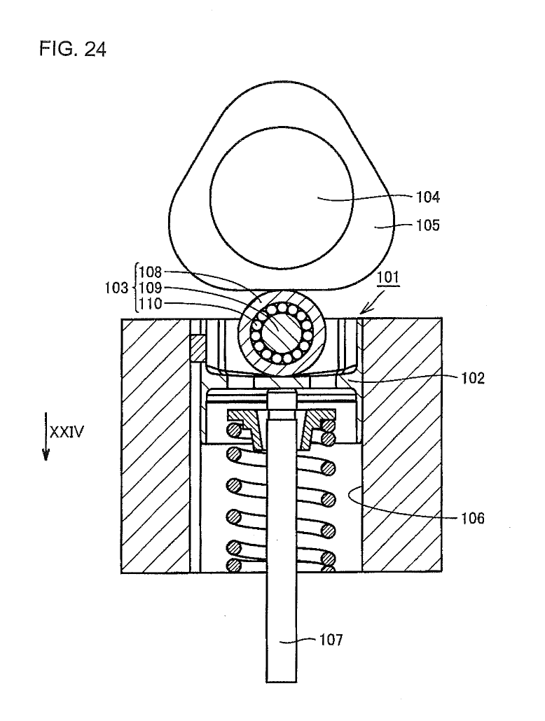

FIG. 22 is a view showing a fitted state of the positioning pin in this case, and corresponds to FIG. 10. Referring to FIG. 22, a recessed part 27b is recessed from an outer diameter surface 27a of a case 27 so as to follow the outer diameter surface 24c of the positioning pin 24. In this case, the recessed part 27b and the positioning pin 24 are more surely fitted by matching the outer diameter surface 24c of the positioning pin 24 and the recessed part 27b of the case 27.

In addition, while the tappet includes one positioning pin and one recessed part in the above embodiment, the present invention is not limited to this, and a plurality of positioning pins and a plurality of recessed parts may be provided. In this case, the circumferential movement of the tappet can be more surely and more appropriately regulated. In this case, the positioning pins and the recessed parts may be provided so as to be aligned in the longitudinal direction at the same circumferential position of the case, or may be provided at the circumferential different positions. In addition, when they are provided in the circumferential direction, a plurality of recessed trenches are provided in the inner diameter surface of the opening hole of the housing so as to correspond to them.

In addition, while the positioning pin is provided such that the longitudinal direction of the case is aligned with the longitudinal direction of the positioning pin in the above, the present invention is not limited to this, and they may be provided such that the longitudinal direction of the case is vertical to the longitudinal direction of the positioning pin.

FIG. 23 is a schematic perspective view showing a part of the tappet in this case, and corresponds to a part of FIG. 4. Referring to FIG. 23, a tappet 30 has three cylindrical positioning pins 28a, 28b, and 28c, and three recessed parts 29a, 29b, and 29c corresponding to them, respectively. The positioning pins 28a to 28c are fitted in a direction vertical to the longitudinal direction of the case. The respective positioning pins 28a to 28c are provided at the longitudinal different positions and at the circumferential same poison of a case 29. In this configuration also, the positioning can be performed while the circumferential movement of the case 29 is regulated.

In addition, while the retainer includes a pair of annular parts, and the plurality of column parts in the above embodiment, the present invention is not limited to this, and the retainer may be a spacer type retainer which is not an integral type but divided into a plurality of members and arranged between the rollers.

In addition, while the column part extends straight in the axial direction in the above embodiment, the present invention is not limited to this, and a column part may be bent in a radial direction as a V type retainer or an M type retainer. Furthermore, a roller stopper part to prevent the roller from escaping in the radial direction may be provided in a side wall surface of the column part.

While the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

A tappet according to the present invention can be effectively used as a car component included in a high-pressure pump to supply a fuel to an engine of a car or two-wheel vehicle.

### EXPLANATION OF REFERENCES

11 . . . HIGH-PRESSURE PUMP, 12 . . . CAM SHAFT, 12A . . . CAM, 12B, 22A, 23H, 24C, 27A, 32A, 34E . . . OUTER DIAMETER SURFACE, 13 . . . PLUNGER, 13A, 14A . . . END PART, 14 . . . SPRING, 15 . . . ENGINE BODY, 16 . . . OPENING HOLE, 16A, 23B, 32B, 34G . . . INNER DIAMETER SURFACE, 16B . . . RECESSED TRENCH, 17 . . . SPRING WASHER, 21, 30 . . . TAPPET, 22 . . . SHAFT, 23, 27, 29 . . . CASE, 23A . . . CIRCUMFERENTIAL WALL, 23C . . . MIDDLE BOTTOM, 23D, 23E . . . SUPPORT HOLE, 23F, 23G . . . SPACE, 23I . . . THROUGH HOLE, 24, 28A, 28B, 28C . . . POSITIONING PIN, 24A . . . END FACE, 24B . . . CHAMFER, 25 . . . OIL HOLE, 26 . . . CIRCLE, 27B, 29A, 29B, 29C . . . RECESSED PART, 31 . . . ROLLER BEARING, 31A . . . ROLLER PITCH CIRCLE, 32 . . . OUTER RING, 33 . . . ROLLER, 33A . . . ROLLING SURFACE, 34 . . . RETAINER, 34A, 34B . . . ANNULAR PART, 34C . . . POCKET, 34D . . . COLUMN PART, 34F . . . OIL TRENCH, 34H . . . SIDE WALL SURFACE

1. A pump tappet to transmit a rotation movement of a cam shaft provided with a cam to a pump plunger as a reciprocation linear movement, and perform a reciprocation linear movement together with said pump plunger, comprising:
a shaft, a roller bearing arranged on an outer diameter side of said shaft and rotatably supported on said shaft, and a case to house said shaft and said roller bearing, wherein
said roller bearing includes an outer ring abutting on said cam, a plurality of rollers arranged between said outer ring and said shaft, and a retainer to retain said plurality of rollers.

2. The pump tappet according to claim 1, wherein
said retainer includes a pair of annular parts, and a plurality of column parts to connect said pair of annular parts so as to form pockets to house said rollers.

3. The pump tappet according to claim 1, wherein
at least one of said roller and said shaft has a nitrogen enrichment layer, the grain size number of its austenite crystal grain size exceeds 10, and its residual austenite amount is 11% by volume to 25% by volume, and its nitrogen content is 0.1% by weight to 0.5% by weight.

4. The pump tappet according to claim 1, wherein
said shaft has a nitrogen enrichment layer, the grain size number of its austenite crystal grain size exceeds 11, and its residual austenite amount is 10% by volume to 50% by volume.

5. The pump tappet according to claim 1, wherein
said roller is subjected to a nitrocarburizing treatment.

6. The pump tappet according to claim 1, wherein
said retainer is provided with an oil trench recessed from its surface to inner side.

7. The pump tappet according to claim 6, wherein
said retainer is a type of an outer diameter guide, and
said oil trench is provided in an outer diameter surface of said retainer.

8. The pump tappet according to claim 6, wherein
said retainer is a type of an inner diameter guide, and
said oil trench is provided in an inner diameter surface of said retainer.

9. The pump tappet according to claim 1, wherein
said retainer is formed of a resin.

10. The pump tappet according to claim 1, wherein
a filling rate of said roller on a roller pitch circle of said roller bearing is 50% to 90%.

11. The pump tappet according to claim 2, wherein
a length of a circumferential shortest part of said column part is 0.15 to 0.5 time as long as a diameter of said roller.

12. The pump tappet according to claim 2, wherein
a circumferential space dimension between a side wall surface of said column part positioned on each circumferential side of said pocket and the roller housed in said pocket is 20 to 200 μm.

13. The pump tappet according to claim 1, wherein
said outer ring is provided with a plurality of fine recessed dents in an outer diameter surface, and
a surface roughness parameter Ryni of the surface with dents (average value of maximum height per reference length) is within a range of 0.8 to 2.3 μm.

14. The pump tappet according to claim 1, wherein
said case is provided with a plurality of fine recessed dents in an outer diameter surface, and
a surface roughness parameter Ryni of the surface with dents (average value of maximum height per reference length) is within a range of 0.8 to 2.3 μm.

15. The pump tappet according to claim 1, wherein
said case is provided with a crowning in an outer diameter surface.

16. The pump tappet according to claim 1, wherein
said case includes a cylindrical circumferential wall, and a middle bottom provided in a middle position of an inner diameter surface of said circumferential wall so as to separate a space vertically, and abutting on said pump plunger, and
a thickness of said middle bottom is larger than that of said circumferential wall.

17. The pump tappet according to claim 16, wherein
said middle bottom is provided with an oil hole penetrating in a thickness direction.

18. The pump tappet according to claim 17, wherein
said oil hole is provided in a position different from an abutment position between said middle bottom and said pump plunger.

19. The pump tappet according to claim 17, wherein
said oil hole is provided outside a circle provided around a radial center of said circumferential wall and having a diameter as long as 50% of an inner diameter of said circumferential wall, in said middle bottom.

20. The pump tappet according to claim 19, wherein
the diameter of said oil hole is as long as 20% or less of the inner diameter of said circumferential wall.

21. The pump tappet according to claim 17, wherein
three or more of said oil holes are provided.

22. The pump tappet according to claim 1, wherein
said case is made of a material containing 0.15 to 0.7% by weight of carbon.

23. The pump tappet according to claim 1, wherein
said case is subjected to either one of a carburizing treatment and a nitrocarburizing treatment.

24. The pump tappet according to claim 1, wherein
said case is made of aluminum.

25. The pump tappet according to claim 1, wherein
said case is made of a resin.

26. The pump tappet according to claim 1, wherein
said case is provided with a recessed part in an outer diameter surface, and
a column-shaped positioning pin to position said case is fitted to said recessed part in such a manner that it partially protrudes from said outer diameter surface.

27. The pump tappet according to claim 26, wherein
said recessed part has a shape recessed from the outer diameter surface of said case so as to follow an outer diameter surface of said positioning pin.

28. The pump tappet according to claim 26, wherein
said positioning pin is pressed and fixed to said recessed part.

29. The pump tappet according to claim 26, wherein
a plurality of said recessed parts and a plurality of said positioning pins are provided.
